(19) United States
(12) Patent Application Publication
(10) Pub. No.: US 2013/0211791 A1
(43) Pub. Date: Aug. 15, 2013

(54) Method of Generalizing 3-Dimensional Building Models Having Level of Detail+

(71) Applicants: Fu-an Tsai, New Taipei City (TW); Wan-Jung Lin, New Taipei City (TW); Liang-Chien Chen, Taoyuan County (TW)

(72) Inventors: Fu-an Tsai, New Taipei City (TW); Wan-Jung Lin, New Taipei City (TW); Liang-Chien Chen, Taoyuan County (TW)

(73) Assignee: NATIONAL CENTRAL UNIVERSITY, Taoyuan County (TW)

(21) Appl. No.: 13/548,826

(22) Filed: Jul. 13, 2012

(30) Foreign Application Priority Data
Feb. 9, 2012 (TW) 101104261

(51) Int. Cl. G06F 17/50

(52) U.S. Cl. 703/1

(57) ABSTRACT

Building models having level of detail is generalized. Every single building model is generalized at first. Then, neighboring building models are processed to obtain their geometric relationship. Some of the neighboring building models are combined under specific criteria to further reduce data amount. Thus, the present invention provides smooth building model display and keeps main characteristics of the building models.

### TECHNICAL FIELD OF THE INVENTION

The present invention relates to generalizing building models; more particularly, relates to a two-stage building model generalization for polyhedral three-dimensional building models.

### DESCRIPTION OF THE RELATED ARTS

Three-dimensional (3D) building model is one of the important 3D space information. But, a great amount of 3D building model data will degrade performance of a geographic information system (GIS). For interactive visualization and real-time display, level of detail (LOD) is a well-known technology on reducing data amount of objects. Through generating different LOD models, observers can choose most suitable view of LOD models for different view points or requirements with improved processing efficiency. For reducing data amount, the method for building LOD models is called building model generalization, including single building model generalization and aggregated building model generalization.

An example for single building model generalization is two-dimensional (2D) geometrical calculation of mathematical morphology and curvature space by Mayer, H., 1998. (Three dimensional generalization of building models based on scale-spaces, Technical Report, Technische Universität München, Germany.) This prior art will produce different generalized models through different morphological operators. Another example is provided by Rau, J. Y., L. C. Chen, F. Tsai, K. H. Hsiao, and W. C. Hsu, 2006. (LOD generation for 3D polyhedral building model, Lecture Notes in Computer Science, Springer/Berlin Heidelberg, New York, Vol. 4319, pp. 44-53.) A resolution factor ‘R’ is defined as a parameter for different LOD along with a method for analyzing main structure to generalize polyhedral single building model. However, curve characteristics of the generalized building model are difficult to maintain and popping effect may occur because of sudden changes in LOD. A further example was introduced by Thiemann, F., 2002. (Generalization of 3D building model data, International Archives of Photogrammetry and Remote Sensing, 9-12 July, Ottawa, Canada, Vol. 34, Part 4, unpaginated CD-ROM.) Dent structures and protrusion structures are coordinated with basic models to segment out main building and characteristic structures. Then, Boolean operators are used to build constructive solid geometry (CSG) tree of structures. Thus, various structure combinations obtained various generalized building models. Yet, although characteristics of the building models are kept after generalization, reasonableness of the remained characteristics is to be confirmed.

An example for aggregated building model generalization is the work by Anders, K. H., 2005. (Level of detail generation of 3D building model groups by aggregation and typification, Proceedings of 22nd International Cartographic Conference, 9-16 August, La Coruña, Spain, unpaginated CD-ROM.) Three projected views of neighboring building models are generated. Then, aggregation operators are used to process the views. At last, Boolean operators are used for generalizing the aggregated building model. However, this prior art can only deal with uniform building models, where building models having non-planar roofs can not be processed. Another example is announced by Chang, R., T., Butkiewicz, C., Ziemkiewicz, Z., Wartell, N., Pollard, and W., Ribarsky, 2008. (Legible simplification of textured urban models, IEEE Computer Graphics and Applications, 28 (3): 27-36.; and, Yang, L., L., Zhang, J., Ma, J., Xie, and L, Liu, 2011. Interactive visualization of multi-resolution urban building models considering spatial cognition, International Journal of Geographical Information Science, 25(1): 5-24.) Building models in a region are segmented into model blocks under geometric criteria. Then, the model blocks are combined into aggregated building models to be generalized.

Hence, generalization of 3D building models having LOD is mainly focused on single buildings. But, in a visualization system of a big city, the generalization of single building models is not enough for enhancing performance on displaying areas having high building densities. Besides, styles of building models in a digital city system are various, where generalization based on model blocks is inappropriate for processing the various styles of building models and visual characteristics of the building models may be lost. However, directly applying 2D map generalization concepts on 3D building model generalization for 3D browsing system may not work well. The 2D concepts are very different from 3D concepts and difficult to be used for obtaining good visualization. Hence, the prior arts do not fulfill the requirement for a 3D digital system.

### SUMMARY OF THE INVENTION

The main purpose of the present invention is to provide a two-stage building model generalization for polyhedral 3D building models.

The second purpose of the present invention is to process generalization for excellent visualization by not only considering 2D geometric generalization but also 3D geometric generalization.

The third purpose of the present invention is to provide extra treatment to specific characteristics of building models in a semi-automatically way and process adjustment according to generalized roofs and maintain important visual and geometric characteristics.

To achieve the above purposes, the present invention is a method of generalizing 3D building models having LOD, which integrates generalization of single building models and generalization of aggregated building models and comprises steps of: (a) calculating shape complexity of every building model in a region and detecting the roof structure of the building model; (b) projecting the building model onto at least two vertical planes and one horizontal plane to obtain orthographic views of the building model and obtaining outlines of the orthographic views along different directions through plane geometry; (c) normalizing short-edge structures in the outlines and generalizing dent structures and protrusion structures; (d) obtaining tangent points of extended lines of the outlines of a side view and a front view of the building model intersecting with the outlines of a top-down view of the building model, segmenting the top-down view into parts by the tangent points to be stored as a generalized roof structure, obtaining heights of segmented parts of the roof structure to construct walls corresponding to the segmented parts of the roof structure and thus rebuilding a generalized 3D building model; (e) adjusting generalized shapes and sizes of the roof structure and thus finishing the process of generalizing single building models; (f) inputting the building models in the region and meshing the roof structures of the building models, computing meshed views of the roof structures through morphological operators of dilation and erosion and judging and recording aggregated building models through region growing with a distance threshold; (g) inputting records of the aggregated building models, obtaining areas and average heights of the building models in every one of the aggregated building models and updating data of the aggregated building models in the region after combining the building models in the aggregated building models under specific criteria; and (h) based on the data of the aggregated building models, processing combination of the aggregated building models and finishing the process of generalizing aggregated building models. Accordingly, a novel method of generalizing 3D building models having level of detail is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention;

FIG. 2 is the flow view showing the generalization of the single building model;

FIG. 3 is the view showing the generalization of the projected views;

FIG. 4 is the view showing the re-organization of the projected views;

FIG. 5 is the view showing the adjustment of the roof structures;

FIG. 6 is the flow view showing the generalization of the aggregated building model;

FIG. 7 is the view showing the planar analysis; and

FIG. 8 is the view showing the height analysis.

### DESCRIPTION OF THE PREFERRED EMBODIMENT

The following description of the preferred embodiment is provided to understand the features and the structures of the present invention.

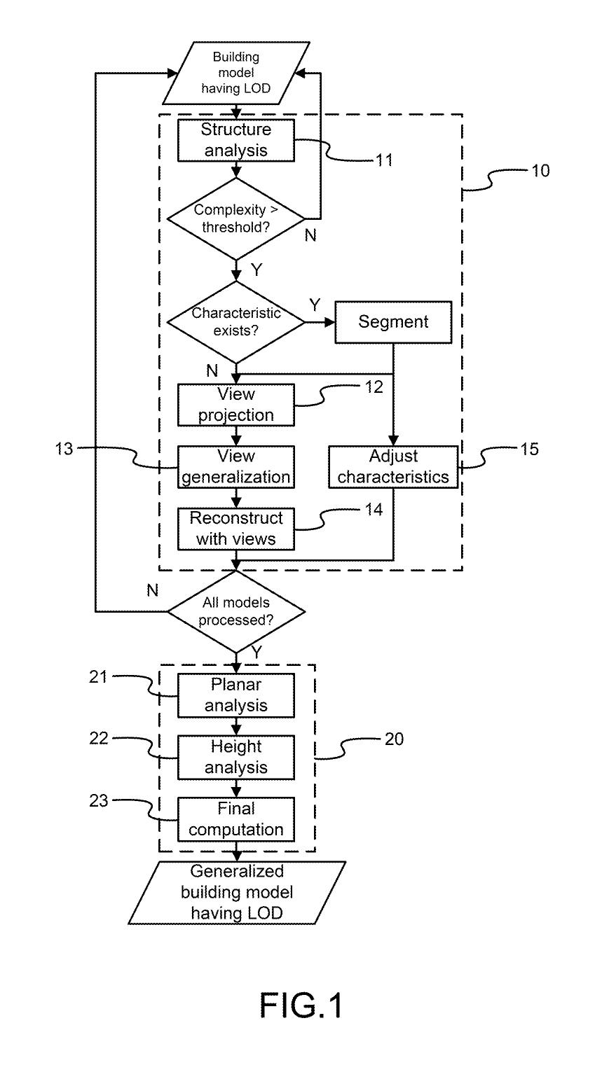

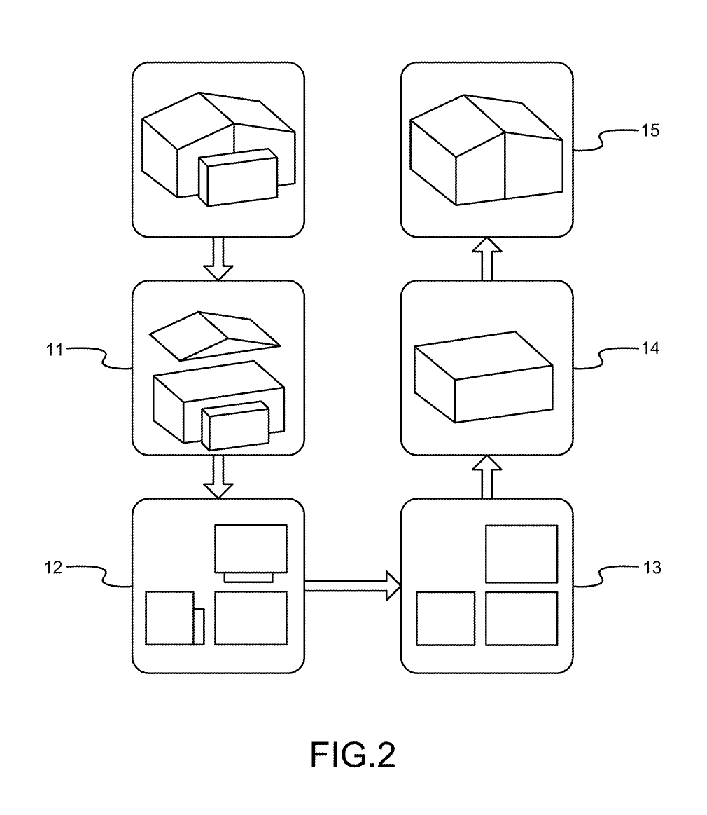

Please refer to FIG. 1 to FIG. 8, which are a flow view showing a preferred embodiment according to the present invention; a flow view showing generalization of a single building model; a view showing generalization of projected views; a view showing re-organization of the projected views; a view showing adjustment of roof structures; a flow view showing generalization of a aggregated building model; a view showing planar analysis; and a view showing height analysis. As shown in the figures, the present invention is a method of generalizing 3D building models having level of detail (LOD), where polyhedral 3D building models are generalized semi-automatically through integrating generalization of single building models 10 and generalization of aggregated building models 20 for reducing data to be processed. As shown in FIG. 2, generalization of single building models 10 comprises the following steps:

(a) Structure analysis 11: Building models having LOD are analyzed, including calculating shape complexity of every building model and detecting roof structure of the building model. Therein, shape complexity of the building model is calculated by introducing convex hulls to estimate planar complexity and height complexity of the building model as parameters for the following generalization of the building model; and, the roof structure of the building model is detected by checking whether the roof is a planar roof and segmenting the roof when the roof is not a planar roof, which is done to avoid loosing the characteristic of the roof during the generalization.

(b) View projection 12: The building model is projected on two manually-selected vertical planes and one manually-selected horizontal plane to obtain orthographic views. Outlines of the orthographic views along different directions are calculated through plane geometry.

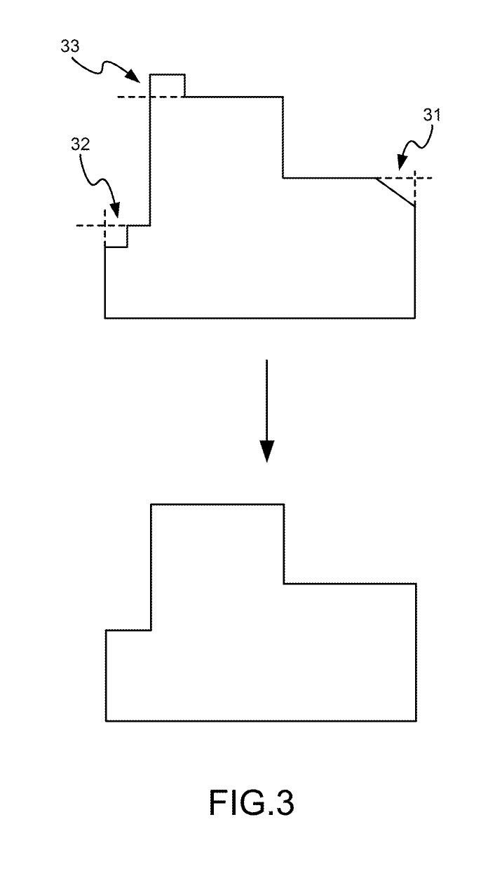

(c) View generalization 13: In FIG. 3, short-edge structures in the outlines are normalized and dent structures and protrusion structures are generalized. Therein, the normalization of short-edge structures 31 is done by removing every section of every structure in the building model which has a length shorter than a length threshold and is not orthogonal to a main axis of the building model, and further generalizing the structure into an orthogonal structure; and, the generalization of dent structures 32 and protrusion structures 33 is done by removing small orthogonal structures in the building model.

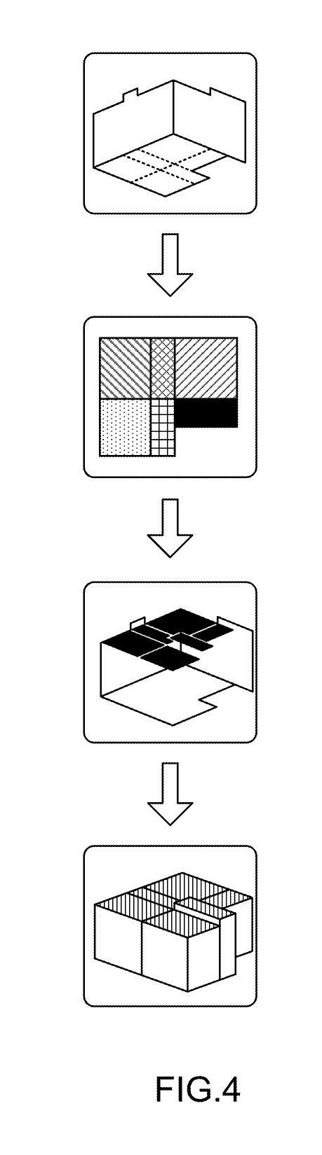

(d) Reconstruction with views 14: Boolean operators are used for reconstructing 3D polyhedral building models. In FIG. 4, extended lines of the outlines of a side view and a front view of the building model are intersected with the outlines of a top-down view of the building model and tangent points are thus obtained on the top-down view at the intersected points, where the tangent points are the corner points of reconstructed building models. Then, the top-down view is segmented into parts by the tangent points to be stored for obtaining a generalized roof structure. After calculating heights of segmented parts of the roof structure, walls are reconstructed corresponding to the segmented parts of the roof structure. Thus, the 3D building model is generalized and rebuilt.

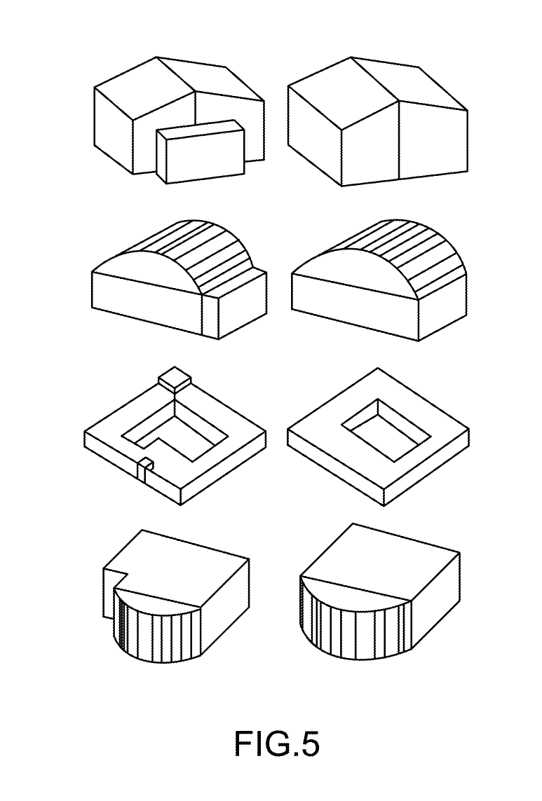

(e) Adjustment of characteristics 15: Adjustment is made to the generalized building model. In FIG. 5, shapes and sizes of the roof structure of the generalized building model is adjusted, where non-planar roof, roofs of yards and roofs having non-flat walls are adjusted. Therein, the non-planar roof is a gable roof or a cambered roof; and, the yard roof and the roofs having non-flat walls are identified to be adjusted manually.

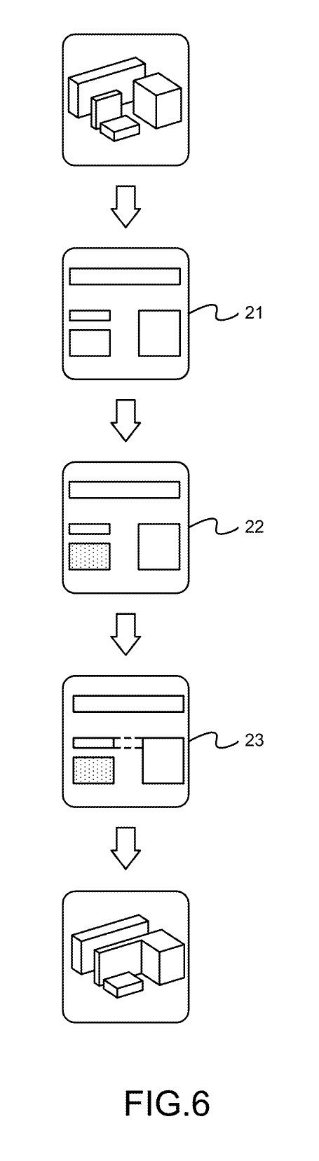

As shown in FIG. 6, generalization of aggregated building models 20 comprises the following steps:

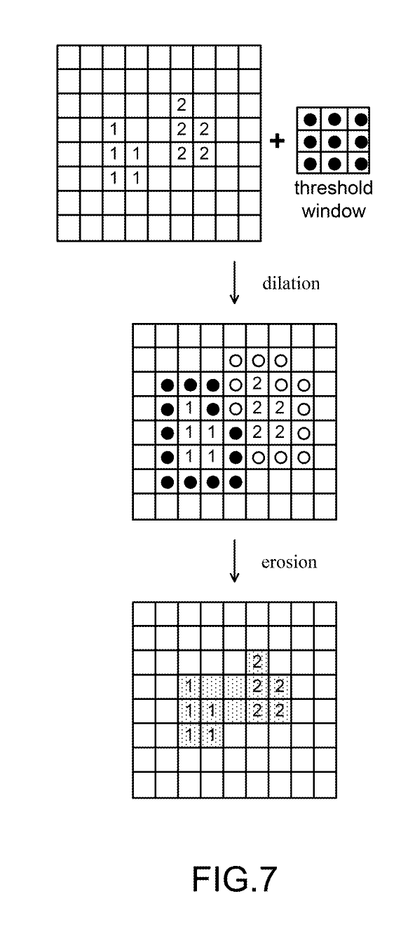

(f) Planar analysis 21: In FIG. 7, a plurality of the building models in the region is inputted and a plurality of the roofs of the building models is meshed. Then, meshed views of the roofs are computed through morphological operators of dilation and erosion. At last, aggregated building models are judged out and recorded through region growing with a distance threshold.

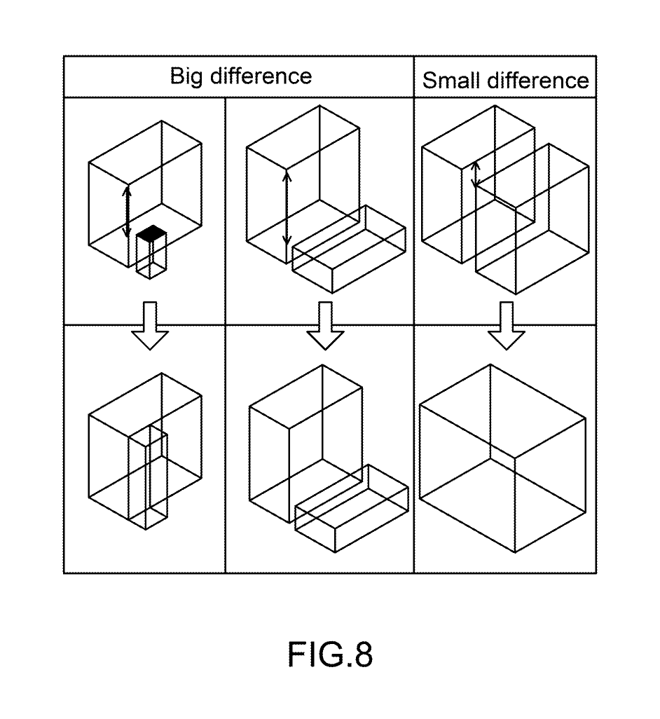

(g) Height analysis 22: In FIG. 8, records of the aggregated building models are inputted for figuring out areas and average heights of the building models in every aggregated building model. Then, a first threshold of height difference (a lower threshold) and a second threshold of height difference (a higher threshold) are set for judgment. When two neighboring building models in the aggregated building model have a height difference smaller than the first threshold, the two neighboring building models are combined and heights of the two neighboring building models are set to a height of the building model having the biggest area in the aggregated building model. When the two neighboring building models have a height difference bigger than the first threshold but smaller than the second threshold, the two neighboring building models are combined if area of the combined neighboring building models is smaller than an area threshold. Except the above two situations, the two neighboring building models are not combined. After necessary combinations of neighboring building models are done under the above specific criteria, data of the aggregated building models in the region are updated.

(h) Final computation 23: Based on the data of the aggregated building models obtained in step (g), final computations of the aggregated building models are processed. Sections of the roofs of the building models in the aggregated building models are intersected to obtain linking lines between neighboring building models. The linking lines are added to the aggregated building models to re-construct the outlines of the aggregated building models. Then, corresponding walls are built with the reconstructed roofs coordinated with corresponding heights. Thus, the building models are aggregated and building models having LOD are obtained.

On using the present invention, every building model in a region is generalized at first and, then, neighboring building models are combined according to their geometric relationship to further reduce data amount to be processed. Therein, for generalizing the building model, parameters for the generalization are set at first and roof style of the building model is determined; then, orthographic views of the building model are generated to be generalized geometrically; and, at last, the views are re-combined to obtain the generalized building model. If the building model has a non-planar roof, the roof is further processed in a semi-automatic way. For generalizing aggregated building model, the generalized building models in the region are processed through 3D geometric analysis. The generalized building models are segmented into aggregated building models; then, linking lines between neighboring building models are obtained through geometric intersections; and, at last, outlines of the aggregated building models are detected to obtain a roof for the combined building models and corresponding walls are built accordingly. Thus, generalized 3D building models having LOD are obtained. The present invention effectively reduces number of corner points and number of roof surfaces of building models. After first iteration of generalization (reducing one level of detail), data is deducted to 60%. After three iterations of generalization, the data is even deducted to 75%. If only the building models were generalized, extra 5% data can be deducted. The present invention not only provides a more reasonable and smoother presentation of building models, but also maintains important geometric characteristics of the building models at different levels of detail.

The present invention provides a two-stage 3D building model generalization for handling 3D polyhedral building models. Every building model in a region is generalized at first and, then, relative positions between neighboring building models are calculated for further reducing data amount and improving system performance. The generalization used in the present invention not only includes 2D geometric generalization but also 3D geometric generalization. Specific characteristics of building models (e.g. gable roof, cambered roof, yard, non-flat wall, etc.) are separately treated to be generalized semi-automatically. At last, the structures of the building models are adjusted according to the generalized roofs with visual characteristics remained.

To sum up, the present invention is a method of generalizing 3D building models having LOD, where building models in a region are generalized and then relative positions of the neighboring building models are calculated for further reducing data amount by generalizing aggregated building models and system performance is thus improved with data amount reduced.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of generalizing 3-dimensional (3D) building models having level of detail (LOD), said method integrating generalization of single building models and generalization of aggregated building models, said method comprising steps of:
(a) obtaining shape complexity of every building model in a region and detecting a roof structure of said building model,
wherein said shape complexity of said building model is obtained by estimating planar complexity and height complexity of said building model as parameters to be used on generalizing said building model; and
wherein said roof structure is detected by checking a roof of said building model to judge whether said roof is a planar roof and segmenting said roof when said roof is not a planar roof;
(b) projecting said building model onto at least two manually-selected vertical planes and one manually-selected horizontal plane to obtain orthographic views of said building model and obtaining outlines of said orthographic views along different directions through plane geometry;
(c) normalizing short-edge structures in said outlines and generalizing dent structures and protrusion structures,
wherein said normalization of short-edge structures is done by removing every section of every structure in said building model which has a length shorter than a length threshold and is not orthogonal to a main axis of said building model and by generalizing said structure into an orthogonal structure; and
wherein said generalization of dent structures and protrusion structures is done by removing small ones of said orthogonal structures in said building model;
(d) obtaining tangent points of extended lines of said outlines of a side view and a front view of said building model intersecting with said outlines of a top-down view of said building model, segmenting said top-down view into parts by said tangent points to be stored to obtain a generalized roof structure, obtaining heights of segmented parts of said roof structure to construct walls corresponding to said segmented parts of said roof structure and thus rebuilding a generalized 3D building model;
(e) adjusting generalized shapes and sizes of said roof structure and thus finishing said process of generalizing single building models;
(f) inputting a plurality of said building models in said region and meshing a plurality of said roof structures of said building models, computing meshed views of said roof structures through morphological operators of dilation and erosion and judging and recording aggregated building models through region growing with a distance threshold;
(g) inputting records of said aggregated building models, obtaining areas and average heights of said building models in every one of said aggregated building models and updating data of said aggregated building models in said region after combining said building models in said aggregated building models under specific criteria,
wherein a first threshold of height difference, a second threshold of height difference and an area threshold are set;
wherein, when two neighboring building models in said aggregated building model have a height difference smaller than said first threshold of height difference, said two neighboring building models are combined and heights of said two neighboring building models are set to a height of the building model having the biggest area in said aggregated building model; and
wherein, when said two neighboring building models have a height difference bigger than said first threshold of height difference but smaller than said second threshold of height difference, said two neighboring building models are combined if area of said combined neighboring building models is smaller than said area threshold; and
(h) based on said data of said aggregated building models, processing combination of said aggregated building models and finishing said process of generalizing aggregated building models,
wherein sections of said roof structures of said building models in said aggregated building models are intersected to obtain linking lines between neighboring building models; said linking lines are added to said aggregated building models to re-obtain said outlines of said aggregated building models; and corresponding walls are built with said reconstructed roof structures coordinated with corresponding heights.

2. The method according to claim 1,
wherein, in step (a), said shape complexity of said building model is obtained by using convex hulls to estimate planar complexity and height complexity of said building model.

3. The method according to claim 1,
wherein, in step (d), said generalized 3D building model is rebuilt by re-combining projected views with Boolean operators.

4. The method according to claim 1,
wherein, in step (e), said roof structure adjusted is selected from a group consisting of a non-planar roof structure, a roof structure of a yard and a roof structure having non-flat wall.

5. The method according to claim 4,
wherein said non-planar roof structure is selected from a group consisting of a gable roof structure and a cambered roof structure.

6. The method according to claim 4,
wherein said roof structure of a yard and said roof structure having non-flat wall are identified to be adjusted manually.
